(19) United States
(12) Patent Application Publication
(10) Pub. No.: US 2009/0075636 A1
(43) Pub. Date: Mar. 19, 2009

(54) METHOD AND SYSTEM FOR TRANSMITTING THE IDENTITY OF A USER IN A MOBILE TELECOMMUNICATIONS NETWORK

(76) Inventor: Bindu Akam, Andhra Pradesh (IN)

Correspondence Address: BELL, BOYD & LLOYD, LLP, P.O. BOX 1135, CHICAGO, IL, 60690, US

(21) Appl. No.: 11/910,602

(22) PCT Filed: Apr. 3, 2006
(86) PCT No.: PCT/EP2006/061273

§ 371 Date: Sep. 10, 2008

(30) Foreign Application Priority Data
Apr. 7, 2005 (IN) 900/DEL/2005

(51) Int. Cl. H04M 3/42

(52) U.S. Cl. 455/415

(57) ABSTRACT

The invention consists of a method and a system arranged to transmit an identity of a user from a terminal to a database adapted to permanently store information of said user, in a mobile telecommunications network, comprising: inputting means adapted to allow said user to input said identity at said terminal, whereby said identity is modified on a permanent basis by said user; transmitting means adapted to transmit in the form of a message, said identity from said terminal to said database; storing means adapted upon reception of said message to store said identity at said database.

### TECHNICAL FIELD OF THE INVENTION

The invention relates to a system and method for transmitting the identity of a user in a mobile communication network, and in particular to ensure that a calling party's identity is displayed at a called party in a manner suitable to the calling party while decreasing the time needed for establishing a call.

### BACKGROUND OF THE INVENTION

Today's mobile communications networks with the advent of GSM (Global System for Mobile Communications) and UMTS (Universal Mobile Telecommunications Standard), it has become possible to provide an increasing number of services to mobile users. These services, provided by network operators, allow a mobile terminal to be extremely versatile and attractive to prospective buyers. Such services allow for a user to browse the internet, download traffic information etc.

Such services are the line and name identification services, which provide both the calling and the called party the option to allow or restrict the display of calling or connected entities, like numbers or names. Usually, the calling line identity that is to be displayed at the called party side is provided by the subscriber's HLR (Home Location Register), whereas the calling name to be displayed is obtained from a calling name database. During call set up, the calling line identity is used to query the calling name database.

Furthermore, network providers are coming up with services that can provide the calling party the option to keep the calling number private but at the same time allow the called party to know the caller's calling name.

However, systems lack the ability for the calling party to modify the calling name that is to be displayed at the called party. Normally, the calling name that is displayed at the called party is the name with which the subscription is registered and is stored in the calling name database or is the name stored in the called party's phonebook. In both cases it can not be changed without the intervention of the network provider or the called party.

Furthermore, operators also provide payphone and mobile phone rental services, whereby subscribers are provided with mobile phones that contain a Subscriber Identity Module SIM card for temporary use. However, in these cases the calling number is hidden from view. Therefore the caller has no possibility in identifying himself to the called party. This can lead to calls being rejected, as called parties do not answer unidentified calls. Additionally, when setting up a call between a caller party and a called party, querying the calling name database in order to extract the required information is necessary which, in turn, increases the time taken to set up the call and the cost of the call. Such an example can be seen in U.S. Pat. No. 6,343,120 to Rhodes, whereby a caller identity alias is provided by a caller and located in a name database. The caller can provide multiple aliases for his calling number. Each alias is associated with a particular status indicator field. When a call is established between the caller and a called party, a terminating Local Exchange Switch LEC, if the called party is located in a fixed network, or a terminating Mobile Switching Centre MSC, if the called party is located in a mobile network, will send upon receiving a request for a call establishment with the called party, a query to the name database in order to associate the calling number with a calling name. Depending now on the particular status indicator field that is provided with the calling number, the query will then access the database and retrieve the appropriate alias to be displayed at the called party. The amount of time required to retrieve the alias can be significant and thus increase the time needed to set up the call.

In FIG. 1, a diagram of the message flow used to perform a call set up is shown. A user (calling party) MS1 wanting to set up a call to another user (called party) MS2, transmits a call set up message to its serving Mobile Switching Centre MSC1. The Mobile Switching Centre MSC1, in turn, transmits a set up request that includes the calling line identity to the serving Mobile Switching Centre MSC2 of the called party. The Mobile Switching Centre MSC2, requests information concerning the validity of the called party from a Visitor Location Register VLR2, that it is connected to. After the information request has been acknowledged, the Mobile Switching Centre MSC2, then queries a name database located in the network in order to retrieve the identity, for example the name of the calling party, by providing the calling line identity. Once the identity has been retrieved then the Mobile Switching Centre MSC2 contacts the called party in order to establish the call and provides the called party with the identity of the calling party.

With today's technology it is possible for a user to transmit solely text strings, which represent, for example, the name that the user wants to transit, or photographs with or without a text string attached. Both of these options form the user's identity, that can be transmitted to an end user (called party) when setting up a call.

### SUMMARY OF THE INVENTION

Decreasing the time to retrieve call aliases, and at the same time allowing a subscriber or a user the freedom to modify the identity which is displayed when setting up a call, is disclosed in the invention. The invention decreases the time taken for a query to be performed and allows a user to modify his/her identity on a permanent basis.

In one embodiment of the invention, there is a method of transmitting an identity of a user from a terminal to a database and permanently storing information of the user, in a mobile telecommunications network, including receiving input from the user at the terminal representing the identity, whereby the identity is modified on a permanent basis by the user, transmitting from the terminal in the form of a message, the identity to the database, and storing upon reception of the message the identity at the database.

In another embodiment of the invention, there is a system to transmit an identity of a user from a terminal to a database adapted to permanently store information of the user, in a mobile telecommunications network, including an input device adapted to allow the user to input the identity at the terminal, whereby the identity is modified on a permanent basis by the user,

a transmitting device adapted to transmit in the form of a message, the identity from the terminal to the database, and a storage device adapted upon reception of the message to store the identity at the database.

The combination of the features results in the reduction of the time taken to perform a query and therefore reduce the amount of time for a call to be set up between two parties. Furthermore, they also allow a user to modify his/her identity on a permanent basis.

Further advantages include, for example, a user's ability to modify and use a textual string and/or a photograph as an identity, and whereby the database is a Home Location Register, and whereby the database downloads the identity to another database that stores the identity temporarily.

### BRIEF DESCRIPTION OF THE DRAWINGS

The present invention will become more fully apparent from the detailed description given herein-below and the accompanying drawings which are given by way of illustration only, and thus are not limitative of the present invention, and wherein:

FIG. 1 shows a message flow chart indicating a call set up between two mobiles stations and how the name of the caller party is transmitted to the called party as performed in the conventional art.

FIG. 2 shows a block diagram of a network in accordance with the invention.

FIGS. 3a, 3b, and 3c illustrate message flow diagrams in accordance with the invention

FIG. 4 shows a block diagram of the different entities that comprise the system.

FIG. 5 shows a block diagram of the relationship between different entities that comprise the system.

### DETAILED DESCRIPTION OF THE INVENTION

In today's wireless networks, the identity, for example the calling name of a user requesting the set up of a call, is displayed at the called party only if the called party has a subscription with the network operator. In particular, the subscriber has to have a subscription to the Calling Name Presentation CNAP supplementary service. CNAP is a service that is provided for in the Wireless Intelligent Network WIN draft of the Telecommunications Industry Association Standards Committee TR45.2, as well as in IS-764.

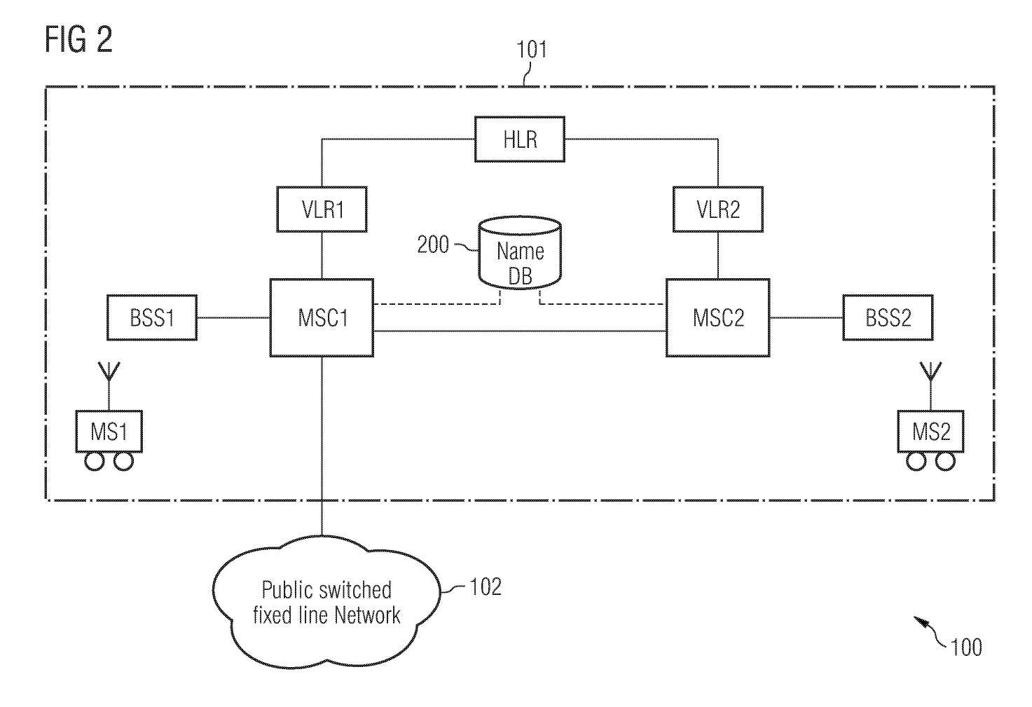

FIG. 2 shows a block diagram of a network where the proposed invention is implemented. Network 100 includes a mobile communications system 101. In addition, also shown is a public switched fixed line communications system 102. The mobile communications system is a GSM or UMTS system. Mobile communications system 101, includes a mobile switching centre (MSC) MSC1 and MSC2, which have connections to visitor locations registers (VLRs) VLR1 and VLR2, and with a home location register HLR. Additionally, the system also includes base station systems (BSSs) BSS1 and BSS2. Also shown are mobile terminals MS1 and MS2. Mobile terminals MS1 and MS2 may be, for example, a cellular phone. Additionally, MSC1 is coupled to the public switched fixed line communications system 102. Also located in system 101 is a name database 200. Even though only two mobile switching centers, two visitor location registers, one home location register, two terminals etc, are illustrated in FIG. 2, it is understood by a person skilled in the art that a mobile communications system, such as the one illustrated, may include more of them.

MSC1 performs switching of a call from the public switched fixed line communications system 102 and vice versa as well as switching a call to another mobile terminal. MSC1 and MSC2 also validate mobile terminals MS1 and MS2 to determine whether the user using those stations is a resident of the system or a roamer by using the visitor location registers VLR1 and VLR2 respectively and home locations register HLR. VLR1 and VLR2 are functional units that dynamically store user information, such as location area, when the user is located in the area covered by a particular VLR. When a roaming mobile terminal enters an area controlled by an MSC, the MSC informs the associated VLR about the mobile terminal and initiates a registration procedure for the mobile terminal. The HLR is a functional unit used for management of mobile users. User information such as VLR address, mobile station, subscriber number are stored within the HLR. The name database 200 is used by MSCs to perform queries in order to associate an identity of a user to a calling number, whenever a procedure to establish a call is received at the MSCs. When a user leaves the area controlled by a particular MSC, the associated VLR will remove the user information of that particular user that has left the area.

According to the invention, in order to reduce the set up time of a call, querying the name database is removed.

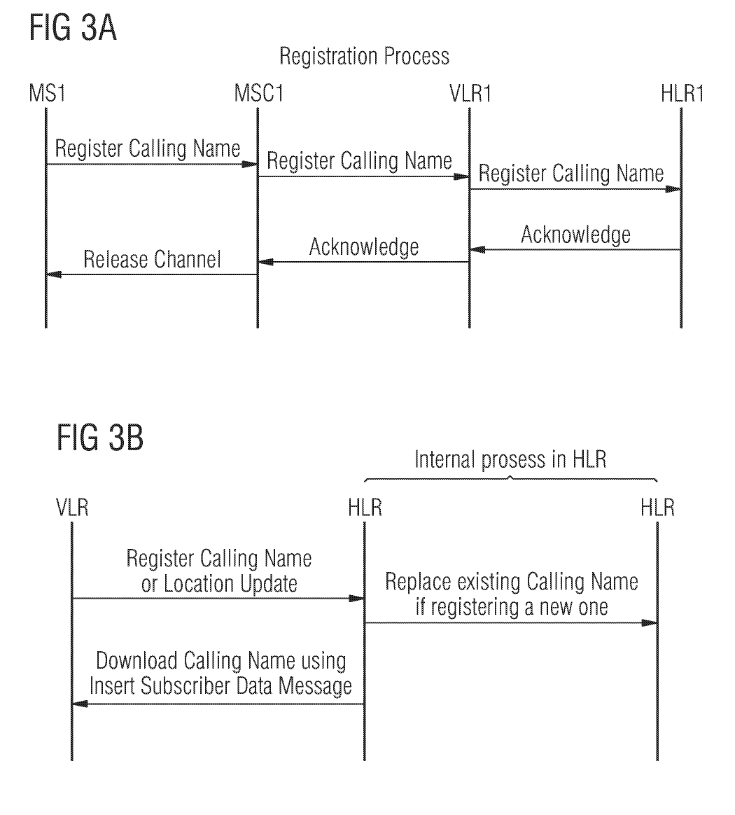

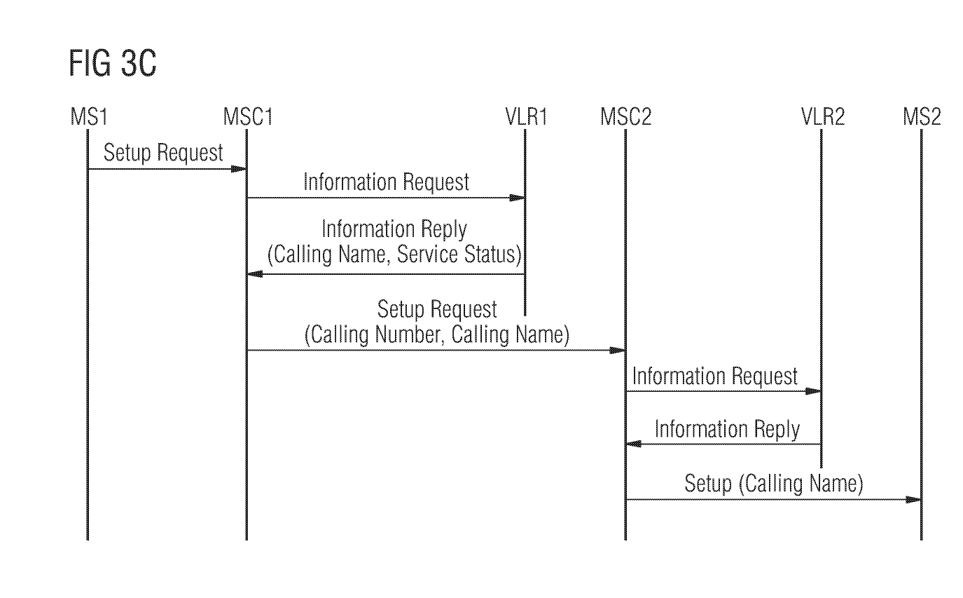

An illustrative embodiment of the technique is shown in FIGS. 3a, 3b, and 3c, wherein message flow diagram showing the different steps required are displayed.

In FIG. 3a, a user (calling party) registers the identity, for example a calling name it wants communicated and displayed at a called party, when establishing a call.

The mobile terminal MS1 used by the user will communicate with its controlling MSC1 via a channel and indicate that it wishes to register an identity (A). This is done by transmitting a message (M) that includes the identity (A). The user has the ability to modify the identity (A) as many times as the user wants, and to effect these modifications at any point in time. There is no limit to the number of modifications allowed nor is there a specific time instance, for example when the user switches on the terminal and connects to the network provider, that a modification of the identity (A) is permitted.

The MSC1 in turn transfers the identity (A) to the corresponding VLR1, which in turn will transfer the identity (A) to the HLR where it will be registered and stored in a database (25). In each step there is a return acknowledgement message transmitted to the emitting entity, in this case mobile terminal MS1. The final acknowledgement between the MSC1 and MS1 indicates that the registration has been executed and that the channel is to be released.

On the occasion that a user registers the identity (A), this is executed using an Unstructured Supplementary Services Data (USSD) string. Alternatively, a user can use a Subscriber Identity Module (SIM) toolkit application (SAM). The HLR has the ability to decode the USSD string and recognize that an identity (A) has been received for registration. The same applies when the SIM toolkit application is used.

Additionally, the HLR performs an internal step of removing upon reception of an identity (A) in a message (M) to be registered, any previously registered identity (A). In this way, one identity (A) is registered at any one time, simplifying the management of associating identities, for example names with numbers, and the also reducing the size of the database.

Once the identity (A) has been registered, the HLR downloads the identity (A) to the VLR at which the mobile terminal is currently registered with. In the event that the mobile terminal is roaming and moves from one MSC to another MSC and therefore a location update is necessary, the HLR transfers the identity (A) to the new VLR upon reception of a location update message. The download of the identity (A) is done using an Insert Subscriber Data Message. Once the mobile terminal has left the old MSC, the user information stored at the old VLR which includes the identity (A) is removed. The above can be seen in FIG. 3b.

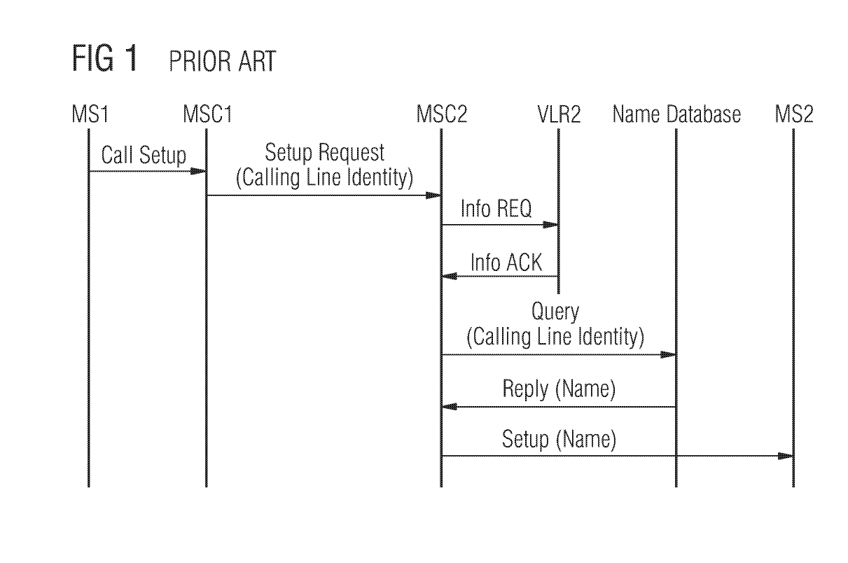

FIG. 3c shows a message flow diagram depicting the steps performed in order to set up the call and provide the called party with the calling party's identity (A). MS1 communicates with MSC1 a request to initiate a call establishment with MS2. MSC1 then communicates with VLR1 requesting information about the user (MS1) who is initiating the call. The VLR provides the required information which includes the identity of MS1. MSC1 then proceeds to communicate with MSC2 requesting the establishment of a call to MS2 and provides MS2 with the identity (A) and calling number of MS1. MSC2, in turn, communicates with VLR2 requesting information about the user MS2. Upon reception of this information, MSC2 establishes the call to MS2 and provides the identity (A) to MS2. Advantageously, compared with the prior art technique, shown in FIG. 1, MSC2 does not have to perform any name database query regarding MS1. MSC1 has already provided this information. This information is retrieved from a smaller set of information stored on the VLR in a database (35) that the mobile terminal is currently located at, thus reducing the amount of time necessary to retrieve the information. All that MSC2 has to perform is the standard query to VLR2 concerning MS2. During this query, MSC2 ascertains whether MS2, has the service allowing the display of identities enabled. If the query returns a positive answer then the identity (A) is displayed. If the answer is negative then only the calling number is displayed.

A further advantage in the event of a negative answer is that MSC2 does not have to perform any further query as in the prior art. MSC2 concerns itself simply with the mobile station under its control. Therefore, reducing the amount of time necessary for retrieving identity (A) information and thus, reducing the overall amount of time necessary for the establishment of the call.

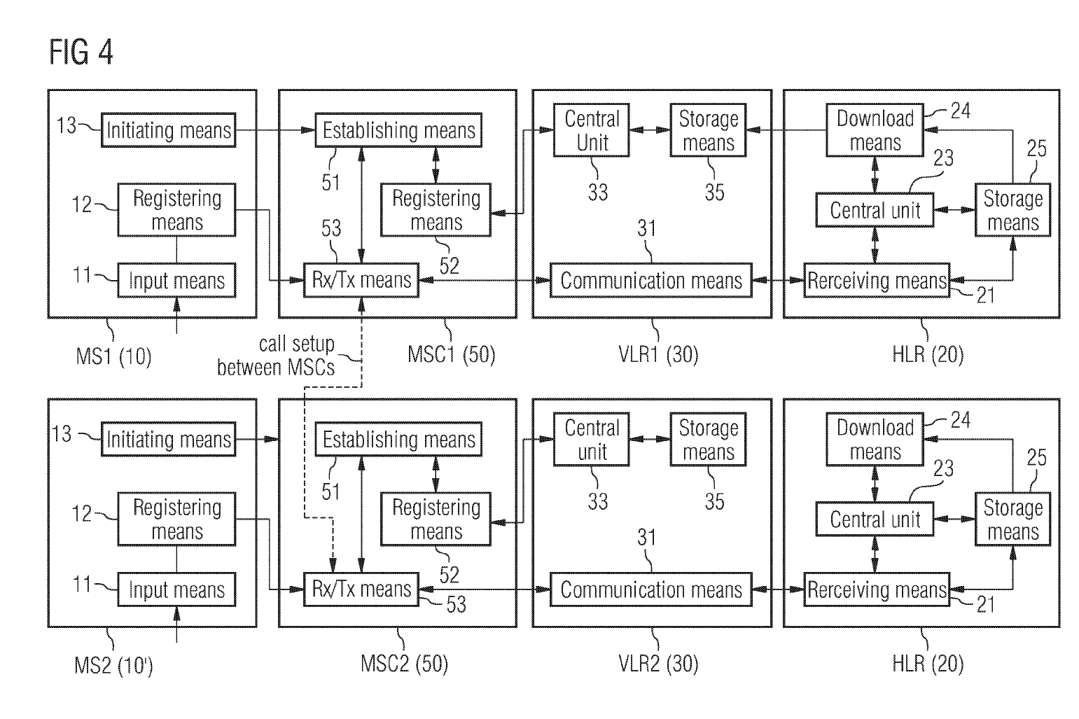

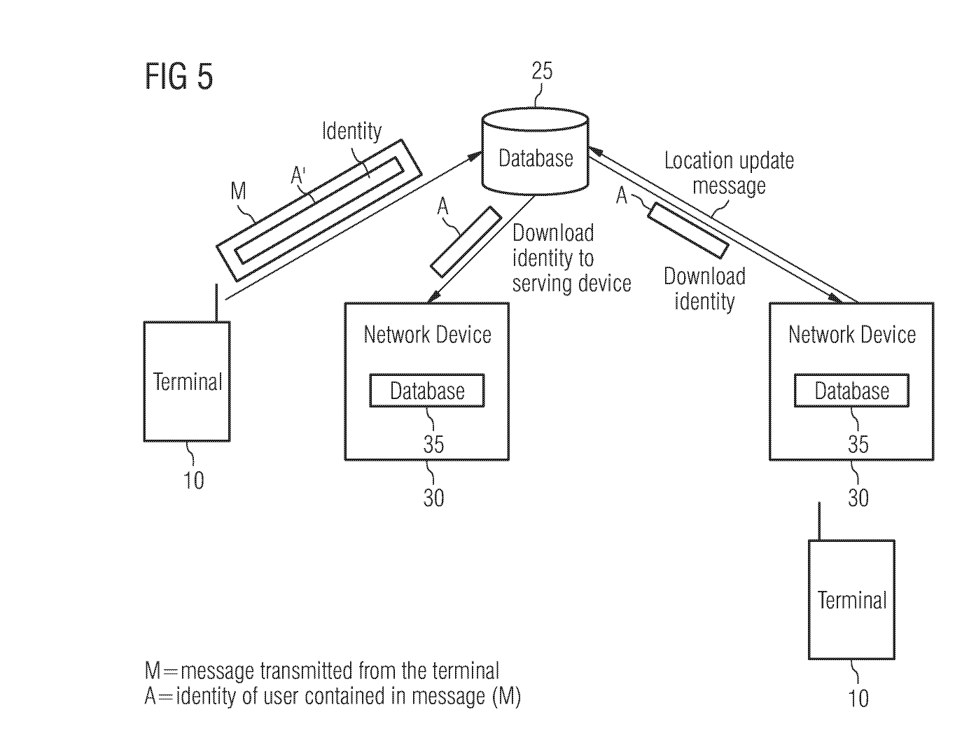

FIGS. 4 and 5, show a block diagram of different entities that comprise the system and their interrelationship. MS1 10 and MS2 10′, both comprise an input device 11, for example the keypad of a mobile phone or a camera, adapted to allow a subscriber to modify his identity (A), i.e. calling name or photograph, and are connected to a registering device 12. The registering device 12 is adapted to communicate and transmit a message (M), including the identity (A) via a Visitor Location Register 30 to a Home Location Register 20. The registering device is adapted to use an Unstructured Supplementary Services Data (USSD) string or a Subscriber Identity Module (SIM) toolkit application (SAM) to transmit the identity. The Visitor Location Register 30 has a communication device 31 adapted to forward the message (M) to the Home Location Registry 40.

The HLR 20 has a receiving device 21 for receiving messages transmitted to the HLR 20 that are adapted to decode a USSD string or a SIM toolkit application and recognize that an identity of a user has been received for registration. The receiving device 21 is also adapted to verify whether there exists a previously registered identity and if there is one such registered identity to remove it. HLR 20, also comprises of a storage device 25, such as a database or memory chip, adapted to store the registered identity. The HLR 20 further comprises a downloading device 24 that is adapted to download the stored identity to the VLR 30. This is executed under the command of a central unit 23, which is in control of the HLR 20.

The VLR 30 or any other VLR that is located within the network comprises of the aforementioned communication device 31, as well as with a storage device 32, such as a database or memory chip, adapted to store the identity downloaded from the HLR 20. The communication device 31 is also adapted to receive and transmit messages to and from the VLR 30. The VLR 30 also comprises a central unit 33 also connected to the storage device 32, that are adapted to receive information requests from MSCs regarding mobile terminals currently located with the MSCs and providing, after retrieving the information from the storage device 32 the requested information.

MS1 10 and MS2 10′ also have an initiating device 13 which is adapted to initiate the establishment of a call to a caller party via MSC1 50 and MSC2 50, respectively. The MSCs comprise of an establishing device 51 adapted to receive a message from the initiating device 13, a retrieving device 52 adapted to communicate with the VLR 30 and request information about mobile terminals. They also comprise of transmit/receive device 53 adapted to receive and transmit any messages, such as those indicating a registration to the VLR 30.

Although the invention has been described in terms of a preferred embodiment described herein, those skilled in the art will appreciate other embodiments and modifications which can be made without departing from the scope of the teachings of the invention. All such modifications are intended to be included within the scope of the claims appended hereto.

1. A method for transmitting an identity of a user, which is provided at a called party, from a terminal to a database storing information of the user, in a mobile telecommunications network, comprising:
receiving input from the user at the terminal representing the identity, whereby the identity is modified on a permanent basis by the user;
transmitting from the terminal as a message, the identity to the database;
storing upon reception of the message the identity at the database.

2. The method according to claim 1, further comprising reception of the message, the database downloading the identity to a different database temporarily storing the identity located on a network device serving the terminal.

3. The method according to claim 2, further comprising downloading the identity upon reception of a location update message.

4. The method according to claim 1, wherein the identity is a text string and/or a photograph.

5. The method according to claim 1, wherein the database is a Home Location Register of a mobile telecommunications network.

6. The method according to claim 1, wherein the network device is a Mobile Switching Centre and the database is a Visitor Location Register.

7. A system arranged to transmit an identity of a user, which is provided at a called party, from a terminal to a database adapted to store information of the user, in a mobile telecommunications network, comprising:
an input device adapted to allow the user to input the identity at the terminal, wherein the identity is modified on a permanent basis by the user;
a transmitting device adapted to transmit as a message, the identity from the terminal to the database;
a storage device adapted upon reception of the message to store the identity at the databases.

8. The system according to claim 7, further comprising a downloading device adapted upon reception of the message, to download the identity from the database to a different database adapted to temporarily store the identity, the database located on a network device arranged to serve the terminal.

9. The system according to claim 8, wherein the downloading device is further adapted to download the identity upon reception of a location update message.

10. The system according to claim 7, wherein the identity is a text string and/or a photograph.

11. The system according to claim 7, wherein the database is a Home Location Register of a mobile telecommunications network.

12. The system according to claim 7, wherein the network device is a Mobile Switching Centre and the databases is a Visitor Location Register.
